(19) United States
(12) Patent Application Publication
(10) Pub. No.: US 2009/0264233 A1
(43) Pub. Date: Oct. 22, 2009

(54) NON-PROFILED RUNNING SURFACE OF A BELT PULLEY

(75) Inventor: Hermann STIEF, EMSKIRCHEN (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 12/425,646

(22) Filed: Apr. 17, 2009

(30) Foreign Application Priority Data
Apr. 19, 2008 (DE) 10 2008 019 808.0

(51) Int. Cl. F16H 7/02; F16H 7/12

(52) U.S. Cl. 474/133; 474/167

(57) ABSTRACT

The invention relates to an assembly drive or traction mechanism drive, which is designed as a belt drive, of an internal combustion engine, with one tensioning roller and/or one deflecting roller which encloses in each case one belt pulley. In the operating state of the belt pulley, a traction mechanism, which is designed as a V-ribbed belt, is guided on the running surface of the belt pulley. Here, the belt pulley of the deflecting roller has a smooth running surface against which the V-ribbed belt is supported with the profiled inner side.

### FIELD OF THE INVENTION

The invention is aimed at a belt pulley which is in particular assigned to a traction mechanism drive of an internal combustion engine. In the installed state, a profiled belt, in particular a V-ribbed belt, is guided on the running surface of the belt pulley.

Belt pulleys of said type are preferably used in so-called assembly drives of an internal combustion engine, in which for example an air-conditioning compressor, a generator or a power-steering pump are driven proceeding from a drive belt pulley, with the individual belt pulleys of the assemblies and the drive pulley being connected by means of a V-ribbed belt. To obtain a sufficient wrap angle of the traction mechanism around the individual belt pulleys, deflecting rollers are used to guide the traction mechanism if required. Deflecting rollers of said type are also used to generate a defined belt layout or defined belt guidance within given installation conditions. To obtain substantially slip-free drive and an optimum transmission of torque of the traction mechanism drive, a sufficient preload of the traction mechanism is required. For this purpose, the traction mechanism is assigned at least one tensioning system, by means of which a sufficient preload of the belt is ensured. A suitable tensioning system is a pivotably arranged tensioning roller, which is in particular supported in a spring-loaded fashion against the traction mechanism.

DE 44 04 193 A1 discloses, together with a schematic front view of an internal combustion engine, two belt drives which are driven correspondingly by two axially offset belt pulleys which are assigned to the crankshaft of the internal combustion engine. A first belt drive, which is also referred to as a control drive or synchronizing drive, is designed to drive two camshafts of the internal combustion engine. For this purpose, all the belt pulleys of the control drive are connected by means of a toothed belt. An assembly drive, by means of which for example a generator or any other desired assembly is driven, is mounted axially in front of the control drive. The driven strand of the control drive and of the assembly drive is assigned a tensioning roller of a tensioning system. On account of the arrangement or installation position of the tensioning roller, the latter is assigned in each case to the smooth back side of the belt, the outer side of the traction mechanism.

It is also known to provide tensioning rollers and/or deflecting rollers with a profiled running surface, wherein in the installed position, the V-ribbed profile of the belt engages in a positively locking fashion into the running surface toothed profile of the tensioning roller or of the deflecting roller.

### OBJECT OF THE INVENTION

The object on which the invention is based is that of reducing the friction losses of belt pulleys of a traction mechanism drive.

### Solution According to the Invention

The above-stated problem is solved according to the invention by means of an arrangement in which, in the operating state, the profiled side of the belt interacts with a running surface, which is completely smooth or smooth to a limited extent, of the belt pulley. In relation to known solutions, said design of the belt pulley dispenses with a positively locking engagement of the V-ribbed profile of the belt into the profiled running surface of the belt pulley. For a belt pulley according to the invention with a non-profiled running surface, it is expedient, in order to ensure sufficient belt guidance, for said belt pulley to be arranged, in the installed state, between two belt pulleys each with a profiled running surface, or belt pulleys with rims. The guidance of the traction mechanism via the V-ribbed belt profile on the smooth running surface of the belt pulley results in an advantageous reduction in friction losses. Here, according to the invention, an entry and exit of the V-ribbed profile of the belt into and out of a running surface profile is dispensed with compared to previous solutions. According to the invention, the running surface of the belt pulley is of smooth or planar design, as a result of which it is not the case that the belt profile is pulled into the running surface wedge profile when the belt profile comes into contact with or runs onto the belt pulley, and released from said running surface wedge profile when the belt runs out of the belt pulley. Both processes of the interaction between the profiled belt and the profiled belt pulley are associated with disadvantageous friction losses and belt flank wear. The non-profiled running surface of the belt pulley advantageously results in an increased belt service life, associated with reduced production costs of the belt pulley, which is also referred to as a pulley. Furthermore, the interaction between the profiled belt side with the smooth running surface of the belt pulley ensures an improved dissipation of water in the region of a contact zone between the belt and the running surface. In the case in particular of an application of traction mechanism drives in vehicles, a disadvantageous risk of slip in the event of heavy rain is effectively avoided.

Further advantageous refinements of the invention are the subject matter of dependent claims 2 to 8.

According to one advantageous refinement of the invention, the running surface, which is completely smooth or smooth to a limited extent, of the belt pulley is delimited at least at one side by a rim. Said measure may be provided for example for traction mechanism drives in which the belt is guided on deflecting rollers or tensioning rollers with correspondingly non-profiled running surfaces, with the belt pulleys alternately having in each case one lateral rim in order to ensure adequate belt guidance. If required, the invention also encompasses a belt pulley whose non-profiled running surface is delimited at both sides by a rim.

The lateral rim or the lateral rims of the belt pulley is/are preferably of radially stepped design. Here, the radial step, which is directed toward the side of the belt, of the rim is adapted substantially to the side profile of the belt.

As an alternative to a completely smooth running surface of the belt pulley, it is also expedient according to the invention to provide the running surface with an encircling bead. Here, the bead, which is also referred to as an encircling radial elevation, has a substantially triangular cross-sectional profile. Said profile is designed so as to engage with play into a belt profile which is formed between two V-ribs of the V-ribbed belt. The interaction of the bead with the belt profile of the V-ribbed belt ensures adequate guidance of the belt on the belt pulley according to the invention, without disadvantageous friction losses thereby being generated.

The belt pulley according to the invention is preferably suitable for positionally fixed deflecting rollers of a traction mechanism drive which, in the operating state, are driven by the encircling belt of the traction mechanism drive. Furthermore, the belt pulley according to the invention may be used as a pivotable tensioning roller which is assigned to a tensioning system of a traction mechanism drive. A tensioning system of said type permits, in the operating state, for example in the event of a lengthening of the belt, an automatic re-adjustment of the traction mechanism by virtue of the tensioning roller, which is for example spring-loaded, being positioned in a pivotable and therefore re-adjustable manner.

It is also expedient to assign the belt pulley, which is designed according to the invention to obtain low friction losses and which has a running surface which is completely smooth or smooth to a limited extent, to assemblies which transmit a low level of power. Suitable for this purpose is for example a water pump, the drive power of which is relatively low, and the drive is ensured if the profiled side of the belt interacts with the smooth running surface of the belt pulley.

The belt pulley according to the invention is preferably produced from a plastic. Alternatively, steel is suitable as a material for the belt pulley. Here, the material selection may be carried out taking into consideration cost-effective production and/or a friction-optimized material pairing between the belt and the belt pulley.

### BRIEF DESCRIPTION OF THE DRAWINGS

Further details and features of the invention can be gathered from the following description of the drawings, which illustrate exemplary embodiments of the invention, and in which:

FIG. 1 shows an assembly drive of an internal combustion engine;

FIG. 2 shows an enlarged illustration of a detail of a belt pulley according to the invention with a non-profiled running surface, on which a profiled V-ribbed belt is guided;

FIG. 3 shows an illustration which corresponds substantially to the exemplary embodiment as per FIG. 2, with the belt pulley enclosing lateral rims;

FIG. 4 shows an illustration as per FIG. 2, with the running surface enclosing an encircling bead which engages with play in a positively locking fashion into a ribbed profile of the V-ribbed belt.

### DETAILED DESCRIPTION OF THE DRAWINGS

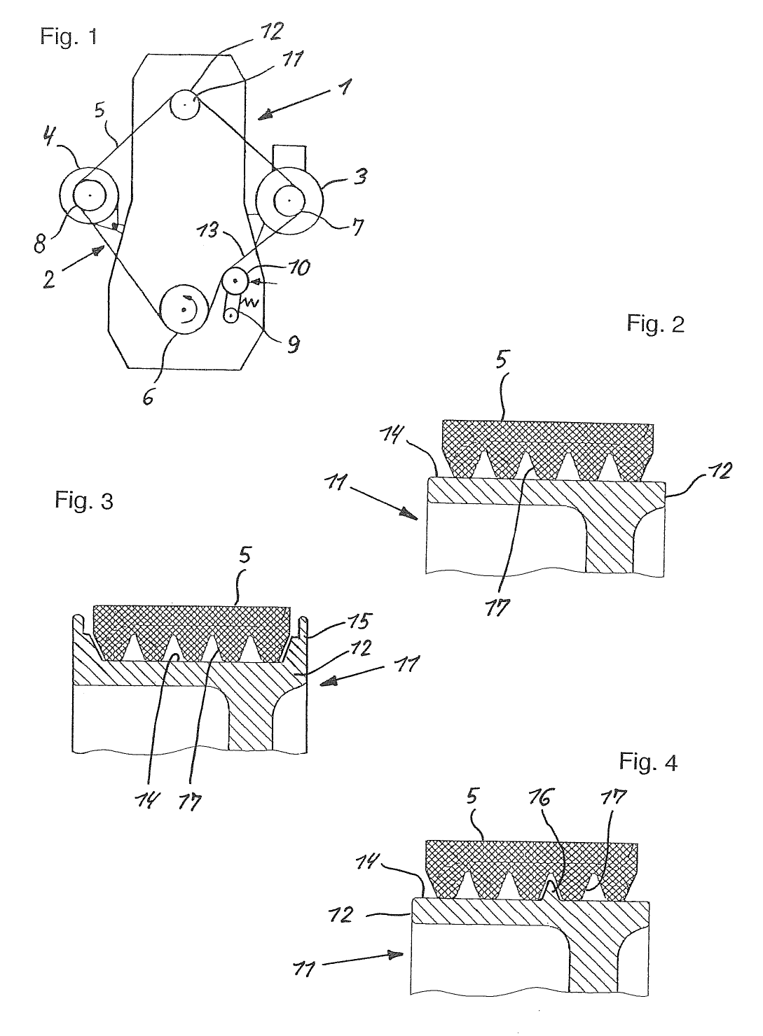

FIG. 1 schematically illustrates an internal combustion engine 1 which, at the end side, is assigned a traction mechanism drive 2. The traction mechanism 2, which is also referred to as an assembly drive, is provided for driving several assemblies, such as a generator 3 and an air-conditioning compressor 4. The drive takes place via a belt pulley 6 which is assigned to a crankshaft of the internal combustion engine 1 and which is connected, by means of a traction mechanism which is designed as a V-ribbed belt 5, to further belt pulleys 7, 8 of the generator 3 or of the air-conditioning compressor 8. Furthermore, the V-ribbed belt 5 is guided on a belt pulley 10 which is assigned to a tensioning system 9 and on a belt pulley 12 of a deflecting roller 11. The tensioning system 9 is assigned to a driven strand 13 of the assembly drive 2, which rotates counter-clockwise, and in the event of a lengthening of the V-ribbed belt 5, generates an automatic re-adjustment of the belt pulley 10 in the direction of the arrow in order to ensure an adequate preload of the V-ribbed belt 5. As a result of the installation position of the positionally fixed deflecting roller 11, the V-ribbed belt 5 is guided with the inner side on the belt pulley 12 of the deflecting roller 11.

FIG. 2 shows, in an enlarged detail view, the support of the V-ribbed belt 5 on the non-profiled or smooth running surface 14 of the belt pulley 12. Here, the running surface 14 extends over a width which exceeds a width of the V-ribbed belt 5. Virtually no friction losses are generated by the contact of the V-ribbed belt profile with the non-profiled running surface 14.

FIG. 3 shows the belt pulley 12, whose running surface 14, in contrast to the illustration as per FIG. 2, is delimited laterally by rims 15. Both rims correspondingly have, at the side pointing toward the V-ribbed belt 5, a radial step which is substantially adapted to an obliquely running lateral contour of the V-ribbed belt 5.

In FIG. 4, the surface 14 has a local radially outwardly directed encircling bead 16 which engages into a V-ribbed profile 17 of the V-ribbed belt 5. Said measure generates adequate guidance of the V-ribbed belt 5 on the running surface 14 of the belt pulley 12. Otherwise, an engagement of the bead 16 with play into the corresponding V-ribbed profile 17 does not generate any disadvantageous friction losses between the V-ribbed belt 5 and the belt pulley 12.

### LIST OF REFERENCE SYMBOLS

1 Internal combustion engine
2 Assembly drive
3 Generator
4 Air-conditioning compressor
5 V-ribbed belt
6 Belt pulley
7 Belt pulley
8 Belt pulley
9 Tensioning system
10 Belt pulley
11 Deflecting roller
12 Belt pulley
13 Driven strand
14 Running surface
15 Rim
16 Bead
17 V-ribbed profile

1. A traction mechanism drive of an internal combustion engine, having at least one belt pulley, in particular a V-ribbed belt, which is guided on a running surface as a traction mechanism, wherein the V-ribbed belt is guided with a profiled side on the running surface, which is completely smooth or smooth to a limited extent, of the belt pulley.

2. The traction mechanism drive according to claim 1, wherein the running surface of the belt pulley is delimited at least on one side by a rim on which the V-ribbed belt is guided.

3. The traction mechanism drive according to claim 2, wherein the lateral rim of the belt pulley is of radially stepped design.

4. The traction mechanism drive according to claim 1 wherein the running surface of the belt pulley has at least one radially encircling elevation designed as a bead and which, in an operating state of the traction mechanism drive, engages with play into a V-ribbed profile of the V-ribbed belt.

5. The traction mechanism drive according to claim 1, wherein the belt pulley is used as a positionally fixed driven deflecting roller.

6. The traction mechanism drive according to claim 1, wherein the belt pulley is used as a driven, pivotable tensioning roller which is connected to a tensioning system.

7. The traction mechanism drive according to claim 1, wherein the belt pulley is assigned to an assembly.

8. The traction mechanism drive according to claim 1, wherein the running surface of the belt pulley is produced from a plastic or from steel.
